(19) United States
(12) Patent Application Publication
(10) Pub. No.: US 2026/0084765 A1
(43) Pub. Date: Mar. 26, 2026

(54) TRACTION AID

(71) Applicant: Rupert Christoph HETTEGGER, Grossarl (AT)

(72) Inventor: Rupert Christoph HETTEGGER, Grossarl (AT)

(21) Appl. No.: 19/107,659

(22) PCT Filed: Sep. 1, 2023
(86) PCT No.: PCT/AT2023/060306

§ 371 Date: Feb. 28, 2025

(30) Foreign Application Priority Data
Sep. 5, 2022 (AT) A50672/2022

(51) Int. Cl. B62D 55/28

(52) U.S. Cl. CPC B62D 55/28

(57) ABSTRACT

A traction aid for a machine with a continuous track includes a support element on which a traction element is arranged, wherein at least one first angle element and at least one second angle element are arranged on the support element, wherein at least one of the two angle elements is detachably connected to the support element, for which purpose the support element has a connecting section, and the at least one detachably connected angle element and the support element are arranged overlapping one another in the connecting region.

The invention relates to a traction aid for a machine with a continuous track, in particular for a tracked vehicle with rubber tracks, comprising a support element on which a traction element is arranged, wherein at least one first angle element and at least one second angle element are arranged on the support element, wherein at least one of the two angle elements is releasably connected to the support element, for which purpose the support element has a connecting section.

The invention also relates to a continuous track for a machine, which has an upper side, which preferably has a profiling with elevations, and with at least one traction aid, which is arranged on the upper side, preferably between two elevations of the profiling.

The ground adhesion of tracked vehicles, such as excavators, suffers in case of poor ground conditions and/or steep terrain because the intermediate spaces between the protruding crossbars of the continuous track fill with absorbed material within a short period of time and then no longer penetrate the ground, rendering them ineffective. To take this condition into account, climbing aids were already suggested in the prior art. For example, DE 20 2012 100 868 U1 discloses an anti-skid device for a continuous track the track plates of which have projecting webs running transversely to the longitudinal direction of the track, with supports for cleats projecting over the webs between in each case two adjacent webs of selected track plates, wherein the supports in each case form two U-shaped holders which engage around the side edges of the track plates and are detachably connected to one another. The U-shaped holders of the supports comprise legs overlapping each other in height in the longitudinal direction of the support and lying against each other in the overlap region with wedge surfaces sloping down against the associated U-shaped holder, which legs are screwed together in the overlap region by means of an elongated hole connection.

AT 520750 A4 describes a climbing aid for a machine having a continuous track, comprising a base body, which is formed of profile elements connected to one another on a lap joint, wherein the profile elements have a girder section, on which a climbing aid profile element is arranged, which protrudes beyond the girder section, and wherein the profile elements of the base body are connected to one another in a positively locking manner in the region of the lap joint, wherein, in order to form the positively locking connection of the profile elements, at least one of these profile elements has a recess on the front side and the profile elements are telescoped in the region of this recess. By pushing the two profile elements into one another, the thus created positive fit has a higher transverse stiffness, whereby the climbing aid, after having been mounted transversely to the driving direction with its longitudinal extension, can be subjected to higher forces in the driving direction.

AT 524130 A4 relates to a climbing aid for a machine with a continuous track, comprising a first and a second angle element, wherein the two angle elements are connected to one another and each have an angled region which encompasses the continuous track, wherein at least one of the angle elements has a fixing element, wherein the continuous track can be arranged between the fixing element and the angle element having the fixing element.

The present invention is based on the object of creating a traction aid which, in particular, can be easily arranged on a rubber track.

The object of the invention is achieved by the initially mentioned traction aid, in which it is provided that the at least one detachably connected angle element and the support element are arranged overlapping one another in the connecting region.

Furthermore, the object of the invention is achieved with the initially mentioned continuous track, which has the traction aid according to the invention.

The advantage of this is that the connection between the support element and the angle element can be improved by the overlapping. This in turn enables a simpler formation of the support element so that it can be better adapted to the geometry of the continuous track. Overall, this makes it possible to achieve a design of the traction aid that is easier to mount on the continuous track.

To further simplify the assembly of the traction aid, according to an embodiment variant of the invention, it may be provided that the connecting section is sleeve-shaped and that the at least one detachably connected angle element is inserted into the connecting section. In addition to the improved load-bearing capacity of the connecting region, the full circumferential encompassing of the angle element with the connecting section can also simplify assembly, since the position of the angle element on the contact element can be predefined more easily by the sleeve shape.

For the same reasons, according to another embodiment variant of the invention, it may be provided that the at least one detachably connected angle element has a sleeve-shaped section into which the connecting section is inserted.

A further simplification of the assembly of the traction aid can be achieved if the first or the second angle element is formed in one piece with the support element. This allows the support element to be pushed onto the continuous track in a first assembly step, which means that a first position of the traction aid can already be loosely fixed.

In order to improve the adaptability of the traction aid to a wide variety of geometries of continuous tracks, according to an embodiment variant of the invention, it may be provided that the support element has two support element parts that are connected to each other and can be displaced relative to each other in a longitudinal direction of the support element.

According to an embodiment variant of the invention, it may be provided that the at least one angle element has a contact element for contact with the continuous track, wherein a contact surface of the contact element which can be placed against the continuous track has a convex curvature. The curvature can reduce the contact surface of the angle element on the continuous track, whereby a higher surface pressure can be achieved. The higher surface pressure can increase the installation safety, so that the traction aid enables improved power transmission, in particular for continuous tracks made of rubber with relatively smooth surfaces in the region where the traction aid makes contact. In addition, the ability of deflection of the continuous track can be improved when the traction aid is mounted.

According to another embodiment variant of the invention, it may be provided that two mutually opposite lateral walls of the connecting section are formed with angled sections, wherein the angled sections extend to the surface of the support element on which the traction element is arranged. On the one hand, this can improve the load-bearing capacity of the connection between the support element and the connecting section if the connecting section is made up of multiple parts. As a side effect, additional traction elements can also be provided on the traction aid.

The mounting of the traction aid on the continuous track can be simplified if, according to a further embodiment variant of the invention, the at least one angle element has an angle between the sections arranged at an angle to one another that is greater than 90° and less than 110°. With this angle formation, the pushing of the angle element onto the continuous track can be simplified. In addition, the surface pressure exerted by the angle element on the continuous track can be increased by reducing the contact surface. This in turn can also contribute to an improved force transmission, as already explained above for the embodiment variant with the curved surface.

According to another embodiment variant of the invention, it may be provided that both angle elements are formed equally and the support element has two connecting sections. This allows for a better adaptation to different material thicknesses of the continuous track, for example due to wear, which can improve the holding strength of the traction aid on the continuous track.

For the purpose of better understanding of the invention, it will be elucidated in more detail by means of the figure below.

These show in a simplified schematic representation:

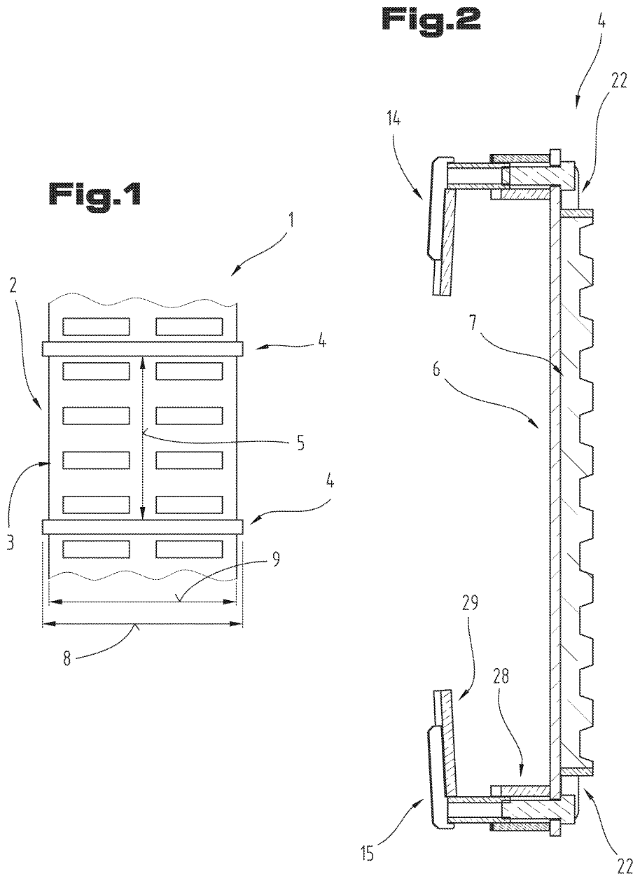

FIG. 1 a section of a continuous track in a top view, with a traction aid arranged thereon;

FIG. 2 a traction aid on a continuous track in a longitudinal section;

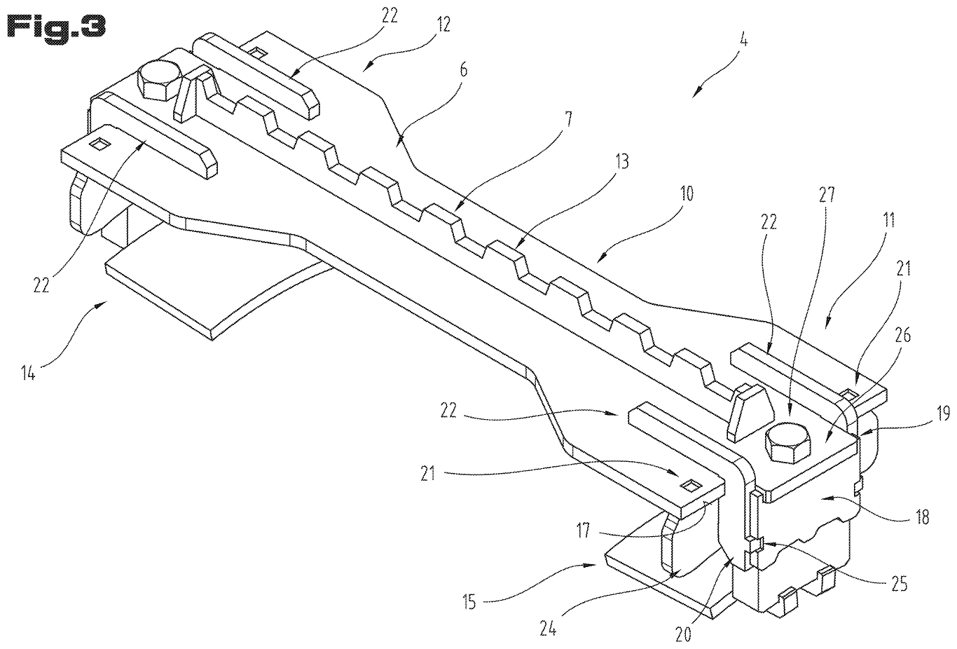

FIG. 3 an oblique view of the traction aid shown in FIG. 2;

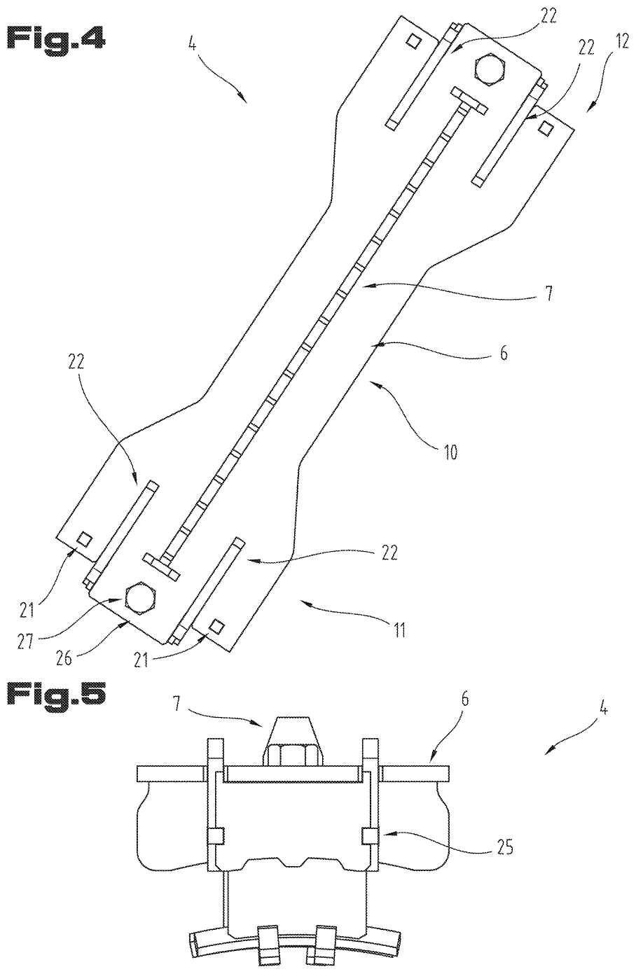

FIG. 4 a top view of the traction aid according to FIG. 2;

FIG. 5 a side view of the traction aid according to FIG. 2;

FIG. 6 a cutout from the traction aid according to FIG. 2 in a longitudinal section;

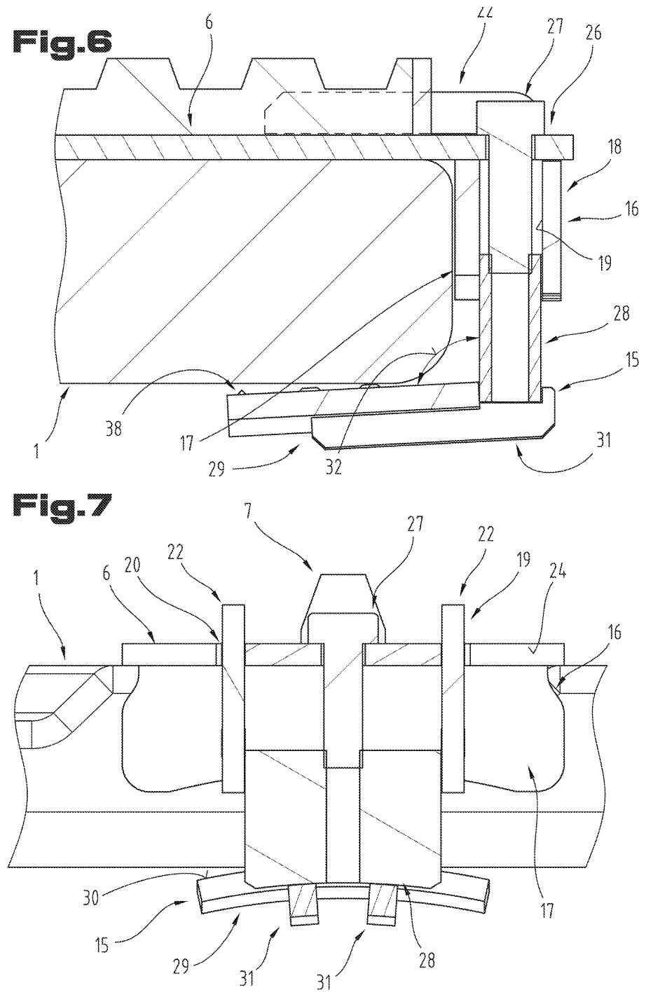

FIG. 7 a cutout from the traction aid according to FIG. 2 in cross-section;

FIG. 8 a cutout from an embodiment variant of a traction aid in a front view;

FIG. 9 a cutout from another embodiment variant of a traction aid in longitudinal section;

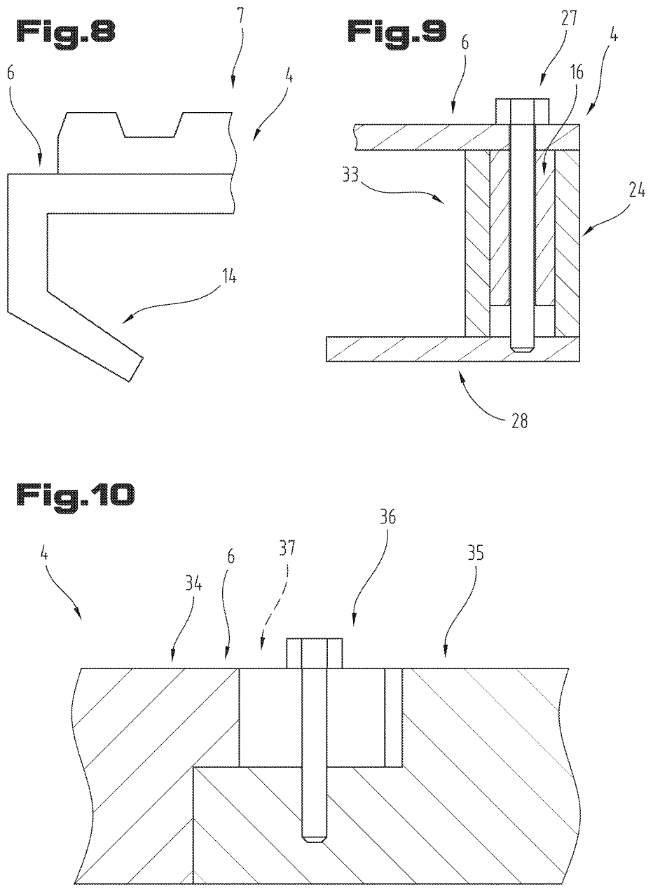

FIG. 10 a cutout from another embodiment variant of a traction aid in longitudinal section.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a continuous track 1 (also known as a rubber track or rubber caterpillar).

The continuous track 1 is intended for a machine, such as an excavator or a snow groomer. Such continuous tracks 1 may have track links connected to each other in an articulated manner via hinge pins and track plates screwed onto these track links. On an upper side that comes into contact with the ground on which the machine stands, the track plates preferably have a profiling 2 with elevations, for example with protruding webs 3 (also known as cleats) running transversely and/or at an angle to the longitudinal direction of the track. The profiling 2 can also be configured differently than shown, so that the illustration in FIG. 1 is only exemplary.

Preferably, the continuous track 1 according to the invention is configured as a circumferential, one-piece rubber track, i.e. without individual, interconnected track links. The profiling 2 is then formed in one piece with the continuous track 1.

In principle, such continuous tracks 1 are known from the prior art, so that reference is made to the relevant prior art, such as DE 20 2012 100 868 U1 and AT 524130 A4 mentioned at the beginning, for further details regarding the structure of the continuous track 1.

If the ground is soggy or frozen, the continuous track 1 may have insufficient grip. To improve the grip, a traction aid 4 (also known as a climbing aid) can be mounted on the continuous track 1. For this purpose, the traction aid 4 can be arranged between two elevations of the profiling 2, for example between two directly adjacent webs 3 of the profiling 2 running transverse to the direction of travel. Depending on requirements, one or multiple ones of these traction aids 4 can be arranged. In the case of multiple traction aids 4, these are preferably arranged at a constant spacing 5 from each other.

FIGS. 2 to 7 show a preferred embodiment variant of the traction aid 4.

It should be mentioned at this point that more than one traction aid 4 is usually mounted on the continuous track 1. Since preferably all traction aids 4 are configured equally, only one traction aid 4 is described in the present description. The explanations regarding the traction aid 4 can also be applied to the other traction aids 4 of the continuous track 1.

The traction aid 4 comprises a support element 6 on which a traction element 7 is arranged.

In the simplest case, the support element 6 can be plate-shaped, in particular completely flat. For example, the support element 6 can be made from a flat steel, e.g. by punching it out of a correspondingly larger blank.

However, the support element 6 can also be embodied differently, for example in the form of a profiled element, etc. Furthermore, the support element 6 can also be manufactured using a different process, e.g. a casting process.

The support element 6 is intended for contact with the continuous track 1, in particular for direct contact. The support element 6 preferably has a longitudinal extension 8 that is greater than a width 9 of the continuous track 1 (shown in FIG. 1). Preferably, the support element 6 projects beyond the continuous track 1 on both sides, as can be seen in FIG. 1.

However, other embodiments of the traction aid 4 are also possible in which the longitudinal extension 8 of the support element 6 is equal to or smaller than the width 9 of the continuous track 1.

The support element 9 has a central region 10, each of which is adjoined by an end region 11, 12. The end regions 11, 12 can be wider than the central region when viewed in a top view onto the traction aid. The widening can be formed abruptly. However, it is also possible, as can be seen from FIG. 4, for example, that the widening in transitional regions between the central region 10 and the end regions 11, 12 can be formed to increase steadily, in particular linearly. In a top view, the transition regions can be trapezoidal, for example. However, other geometric designs are also possible. With this formation with the wider end regions 11, 12, the contact of the traction aid 4 in the region encompassing the continuous track 1 can be configured to be less stressful for the continuous track 1. This is particularly advantageous if the continuous track 1 is made of rubber or has rubber in the region against which the traction aid 4 (directly) rests.

The support element 6 can be formed with a constant thickness over the entire longitudinal extension 8.

The traction element 7 is preferably configured to extend continuously over at least 50%, in particular at least 70%, of the longitudinal extent 8 of the support element 6. Preferably, it is formed in one piece. The traction element 7 is connected to the support element 6, in particular connected by a material bond, preferably welded. In particular, the traction element 7 can be web-shaped. Preferably, it rests with a side end face on the support element 6, as can be seen in FIG. 3.

In particular, the traction element 7 is also made from a flat material and manufactured by machining. It may also have been manufactured using a different process, e.g. a casting process. It has a profiling with elevations 13 (also referred to as claws or teeth) and projects beyond the support element 6 in the vertical direction. With the aid of this profiling, which also projects beyond the profiling 2 of the continuous track 1 in the vertical direction when the traction aid 4 is installed, the continuous track 1 has a better grip during operation, as it can dig further into the ground.

It should be noted that the shape of the profiling of the traction element 7 shown in FIG. 3 is not restrictive, but can also be formed differently, for example with triangular elevations 13 instead of the trapezoidal ones, etc. Furthermore, mixed forms of elevations 13 are also possible, so that the elevations 13 can have different geometries.

The spacings between the elevations 13 can all be the same. However, the elevations 13 can also be formed or arranged at different spacings from one another.

At least one first angle element 14 and at least one second angle element 15 are arranged on the support element 6. In the embodiment variant of the traction aid 4 according to FIGS. 2 to 5, both angle elements 14, 15 are detachably connected to the support element 6. For the detachable connection, connecting sections 16 (which can also referred to as connecting elements) are arranged on the support element 6 for connecting the angle elements 14, 15 to the support element 6. However, as FIG. 8 shows, according to one embodiment variant of the traction aid 4, it is possible for one of the two angle elements 14, 15 to be formed in one piece with the support element 6. For this purpose, the support element 6 can for example be formed accordingly, so that the support element 6 is at least approximately U-shaped in this end region 11 or 12 (as seen in a front view).

In the preferred embodiment variant of the traction aid 4, however, both angle elements 14, 15 are detachably connected to the support element 6. In addition, in the preferred embodiment variant, both angle elements 14, 15 are configured equally and the support element 6 accordingly preferably has two identically formed connecting sections 16. In the following, therefore, only one connecting section 16 and one angle element 15 will be discussed in more detail. However, it should be noted that the connecting sections 16 and/or the angle elements 14, 15 can also have different geometric configurations as long as they fulfill their assigned superordinate function, namely the connection of the traction aid 4 to the continuous track 1.

In the region where the angle elements 14, 15 are connected to the connecting element 16, an overlap is formed between the angle elements 14 and/or 15 and the associated connecting element 16. The overlap region can be single-walled or multi-walled, for example in the form of a flat profile, an L-profile or a U-profile.

In the preferred embodiment variant of the traction aid 4, however, the overlap region is configured in such a way that a full overlap is formed at least in a partial region of the overlap, preferably in the entire overlap region.

Preferably, the connecting section 16 and the angle element 14 and/or 15 are adjacent to one another in the overlap region or are arranged at a spacing of between 0.5 mm and a maximum of 5 mm, in particular a maximum of 2 mm, preferably a maximum of 1 mm, from one another. This can apply to one, multiple ones or all regions of the overlap region, also in the circumferential direction.

The connecting section 16 can have a rectangular or square or generally polygonal or round or oval (clear) cross section in the overlap region, which is adapted to the cross section of the angle element 14 or 15 in the overlap region for receiving it.

For the full overlap of the connecting section 16 and the angle element 14 and/or 15, according to an embodiment variant of the traction aid, it may be provided that the connecting section 16 is sleeve-shaped and that the at least one detachably connected angle element 14 and/or 15 is arranged inserted into the connecting section 16, as can be seen from FIG. 2 and in an enlarged representation from FIGS. 6 and 7. FIGS. 6 and 7 also show the continuous track 1, so that a preferred arrangement of the traction aid 4 on the continuous track can also be seen from these figures.

As can be seen from FIGS. 6 and 7, the sleeve-shaped connecting section 16 can be formed to extend as far as the support element 6. However, it can also be formed with a distance from the support element 6. The sleeve shape not only makes it possible to insert the angle element 14 or 15 into the connecting section 16, but also enables height variability to compensate for continuous tracks 1 of different thicknesses while maintaining high stability. This can be achieved by inserting the angle element 14 or 15 at different depths into the connecting section 16. This also simplifies the use of the traction aid 4 on different continuous tracks 1.

The connecting section 16 can be configured in one part or in multiple parts. In the one-part configuration, the connecting section 16 can be formed as a hollow profile, at least in the overlap region, which hollow profile is connected in particular to the support element 6.

In general, the connecting section 16 can be connected to the support element 6 by a materially bonded and/or positive locking and/or frictional and/or force-fit connection. Preferably, the connecting section 16 is connected to the support element 6 by at least a materially bonded connection.

Profile elements, such as angle profiles or C-profiles, can also be used for the multi-part configuration in order to form the sleeve shape of the connecting section 16. Preferably, however, flat blanks, such as flat steel blanks, are used from which the lateral walls of the sleeve shape are punched out in order to conserve resources. For the embodiment variant of the traction aid 4 according to FIGS. 2 to 7, four wall elements are used, namely a rear wall 17, a front wall 18 and a first and a second lateral wall 19, 20, which produce the connection between the rear wall 17 and the front wall 18.

The rear wall 17 is the wall that is closest to the continuous track 1, and in particular rests against it. It can be connected to the support element 6 by a materially bonded connection. Alternatively or additionally, a positive connection can be established, for example via a positive locking element 21 or multiple positive locking elements 21, as can be seen in FIGS. 3 and 4. The at least one positive locking element 21 can be a projection that protrudes beyond a side surface (or lateral surface) of the rear wall 17 in the direction of the support element 6 and is accommodated in a recess in the support element 6 that is adapted to the shape (cross section) of the positive locking element 21.

Like the rear wall 17, the lateral walls 19, 20 can also extend as far as the support element 6 and be connected to the latter and/or the rear wall 17 by a materially bonded connection and/or a positive locking connection or one of the other connection methods mentioned. For example, the lateral walls 19, 20 can have one positive locking element or multiple positive locking elements. The at least one positive locking element can be a projection that protrudes beyond a side surface (or lateral surface) of the respective lateral walls 19, 20 in the direction of the rear wall 17 and is accommodated in a recess in the rear wall 17 that is adapted to the shape (cross section) of the positive locking element.

The lateral walls 19, 20 can be configured to project upwards beyond the rear wall 17. In an embodiment variant of the traction aid 4, it may be provided that the lateral walls 19, 20 of the connecting section 16 are formed with angled sections 22, wherein the angled sections 22 extend up to the surface of the support element 6 on which the traction element 7 is arranged. The lateral walls 19, 20 can thus be formed as angle elements, in particular be formed at right angles.

The sections 22 can be connected to the support element 6 by a materially bonded and/or a positive locking or one of the other connection methods mentioned.

According to a further embodiment variant of the traction aid 4, it may be provided that the lateral walls 19, 20 are each arranged to engage in a recess in an end face 24 of the support element 6, for example are received in a positive locking manner.

The front wall 18 can be plate-shaped. It can be connected to the support element 6 and/or the lateral walls 19, 20 by a materially bonded and/or a positive locking connection or one of the other connection methods mentioned. The positive locking can be established as a type of prong connection, for which purpose at least one positive locking element 25 configured as a projection can be arranged on the lateral walls 19, 20, which positive locking element 25 protrudes beyond a side surface (or lateral surface) of the respective lateral wall 19, 20 in the direction of the front wall 18 and is accommodated in a recess of the front wall 18 adapted to the shape (cross section) of the positive locking element.

It may further be provided that the support element 6 forms a cover 26 of the connecting section 16. For this purpose, the support element 6 may have corresponding extensions in the end regions 11, 12, which extend into the regions between the lateral walls 19, 20. These covers 26 also serve to support connecting elements 27, with which the angle elements 14, 15 can be connected to the connecting sections 16, in particular can be clamped. The connecting elements 27 are in particular screws, but can also be formed by other suitable elements. However, screws have the advantage that the pretension with which the traction aid 4 is tensioned on the continuous track 1 can be set relatively easily. In addition, the above-mentioned height compensation for different continuous tracks 1 can also be easily realized. To simplify clamping, the connecting elements 27, in particular the screws, are preferably operable from above, i.e. the screw head, for example, is arranged on the same side of the traction aid 4 as the traction element 7. The screws are therefore preferably inserted and screwed from the top downwards, as can be seen from the figures, for example. There may be one connecting element 27 per angle element 14, 15 or there may be multiple connecting elements 27 per angle element 14, 15.

Preferably, the connecting elements 27 penetrate corresponding openings in the support element 6 and extend into bores provided with an internal thread in the angle elements 14, 15. The screws can also be formed with a partially smooth shaft, which makes it easier to avoid contamination of the thread.

Screw/nut connections can also be formed between the connecting section 16 and the angle elements 14, 15, for which purpose the screws can be arranged to penetrate the angle elements 14, 15.

The angle elements 14, 15 have a connecting leg 28 and a contact leg 29.

The angle elements 14, 15 can be configured in one piece, but preferably the connecting leg 28 and the contact leg 29 form separate parts which are connected to one another. The connection is made in particular with a material bond, but can also (if necessary in addition) be made using one of the other connection methods mentioned above.

The connecting leg 28 can be in the form of a plate. The connecting leg 28 serves to receive the at least one connecting element 27, in particular the screw, and to insert it into the connecting section 16 and/or the overlapping arrangement with the connecting section 16.

The contact leg 29 is used to place the traction aid 4 against the underside of the continuous track 1. In other words, the contact leg 29 and/or the angle element 14 or 15 together with the connecting sections 16 achieve lateral gripping and under-gripping of the continuous track 1. A U-shaped receiving area for the continuous track 1 is formed with the contact leg 29.

In the simplest embodiment variant, the contact leg 29 is configured as a flat plate element. According to another embodiment variant of the traction aid 4 shown in the figures, it may be provided that, for contact with the continuous track 1, the contact leg 29 has a contact surface 30 which can be placed against the continuous track 1 and which has a convex curvature. Preferably, the entire contact leg 29 is convexly curved.

To reinforce the angle element 14 and/or 15, according to a further embodiment variant, it may be provided that one reinforcing web 31 or multiple reinforcing webs 31 is/are arranged on the underside of the contact leg 29. The reinforcing web 31 or multiple reinforcing webs 31 can be connected to the connecting leg 28, in particular by at least one of the methods mentioned above. According to an embodiment variant, it may be provided that the receptacles for the connecting elements 27 are not configured as blind holes, but as openings which protrude through the entire connecting leg 27, as can be seen in FIG. 7. It may be provided that the reinforcing webs 31 are inserted into these openings. In this way, the reinforcing webs 31 can simultaneously form a closure for the openings and thus prevent soiling of the openings on the inside.

The connecting leg 28 and the contact leg 29 can be arranged at right angles to each other or at an acute angle to each other. According to an embodiment variant of the traction aid 4, however, it may be provided that the at least one angle element 14 or 15 has an angle 32 between the sections arranged at an angle to one another, i.e. between the connecting leg 28 and the contact leg 29, which is greater than 90° and less than 110°.

According to another embodiment variant of the traction aid 4 shown in FIG. 9, it may be provided that the at least one detachably connected angle element 14 or 15 has a sleeve-shaped section 33 into which the connecting section 16 is inserted. The sleeve-shaped section 33 can form the connecting leg 28. This sleeve-shaped section 33 can be formed in multiple parts or preferably in one part as a hollow profile. In this embodiment variant, the connecting section 16 can be formed as a simple plate element. To connect the angle element 14 and/or 15, the connecting section 16 can have at least one opening through which the connecting element 27 protrudes. The connection (screw connection) can be made with the contact leg 29, for which purpose this can have at least one hole with an internal thread. A screw connection with a screw nut resting on the bottom of the contact leg 29 is also possible.

For the width compensation and/or for an adaptation to different widths 9 of continuous tracks 1, it can be provided according to an embodiment variant that the support element 6 has two support element parts 34, 35 which are connected to each other and can be displaced relative to each other in a longitudinal direction (the longitudinal extension 8 in FIG. 1) of the support element 6, as shown in FIG. 10 in sections. The two support element parts 34, 35 can form a lap joint 36 with each other. In the lap joint 36, the two support element parts 34, 35 are connected to each other, for example screwed together. In order to change the length, at least one elongated hole is formed in at least one of the two support element parts 34, 35 in this embodiment variant, through which the connecting element, for example the screw, protrudes.

According to a further embodiment variant of the traction aid 4, it may be provided that friction-enhancing structural elements 38 are arranged or formed on the contact surface 30 of the contact leg 29 in order to form a positive fit with the contact leg 29 when the continuous track 1 is clamped, if the continuous track 1 has a soft surface, for example a rubber surface, in this area. The structural elements 38 projecting beyond the contact surface 30 can be formed in one piece with the contact surface 30 by structuring its surface accordingly. However, the structural elements 38 can also be provided by a coating of the contact surface 30. The coating can, for example, be based on synthetic resin, wherein hard particles, e.g. corundum or diamond particles, can be embedded in this coating, which protrude beyond the coating. Instead of a synthetic resin, a metallic matrix, e.g. a nickel matrix, can also be used.

Such structural elements 38 can also be provided on other surfaces of the traction aid 4, for example on the underside of the contact element 6.

To mount the traction aid 4 on the continuous track 1, the support element 6 is first placed on the continuous track 1. Then the at least one angle element 14 or 15 or the two angle elements 14, 15 are inserted into the connecting sections 16 or pushed onto the connecting sections 16 and fixed and/or clamped by means of the connecting elements 27.

In addition to the traction element 7, ice claws can be provided for particularly harsh winter conditions. These ice claws may be plate-shaped, for example, and formed at their front end with elevations similar to the elevations of the traction element 7. The ice claws can be arranged at least approximately orthogonally to the traction element 7.

It is also possible for more than one traction element 7 to be arranged on the support element 6, for example two web-shaped traction elements 7 running side by side.

The exemplary embodiments show and/or describe possible embodiment variants of the traction aid 4, while it should be noted at this point that combinations of the individual embodiment variants are also possible.

Finally, as a matter of form, it should be noted that for ease of understanding of the structure of the traction aid 4 and/or its components, these are not obligatorily depicted to scale.

### LIST OF REFERENCE NUMBERS

1 Continuous track
2 Profiling
3 Web
4 Traction aid
5 Spacing
6 Support element
7 Traction element
8 Longitudinal extension
9 Width
10 Central region
11 End region
12 End region
13 Elevation
14 Angle element
15 Angle element
16 Connecting section
17 Rear wall
18 Front wall
19 Lateral wall
20 Lateral wall
21 Po
22 Section
23
24 End surface
25 Positive locking element
26 Cover
27 Connecting element
28 Connecting leg
29 Contact leg
30 Contact surface
31 Reinforcing web
32 Angle
33 Section
34 Support element part
35 Support element part
36 Lap joint
37 Elongated hole
38 Structural element

1: A traction aid (4) for a machine with a continuous track (1), comprising a support element (6) on which a traction element (7) is arranged, wherein at least one first angle element (14) and at least one second angle element (15) are arranged on the support element (6), wherein at least one of the two angle elements (14, 15) is detachably connected to the support element (6), for which purpose the support element (6) has a connecting section (16), wherein the at least one detachably connected angle element (14, 15) and the support element (6) are arranged overlapping one another in the connecting region.

2: The traction aid (4) according to claim 1, wherein the connecting section (16) is sleeve-shaped and wherein the at least one detachably connected angle element (14, 15) is inserted into the connecting section (16).

3: The traction aid (4) according to claim 1, wherein the at least one detachably connected angle element (14, 15) has a sleeve-shaped section (33) into which the connecting section (16) is inserted.

4: The traction aid (4) according to claim 1, wherein the first or the second angle element (14, 15) is formed in one piece with the support element (6).

5: The traction aid (4) according to claim 1, wherein the support element (6) has two support element parts (34, 35) which are connected to each other and can be displaced relative to each other in a longitudinal direction of the support element (6).

6: The traction aid (4) according to claim 1, wherein the at least one angle element (14, 15) has a contact leg (29) for contact with the continuous track (1), wherein a contact surface (30) of the contact element (29) which can be placed against the continuous track (1) has a convex curvature.

7: The traction aid (4) according to claim 1, wherein two mutually opposite lateral walls (19, 20) of the connection section (16) are formed with angled sections (22), wherein the angled sections (22) extend up to the surface of the support element (6) on which the traction element (7) is arranged.

8: The traction aid (4) according to claim 1, wherein the at least one angle element (14, 15) has an angle (32) between the sections arranged at an angle to one another which is greater than 90° and less than 110°.

9: The traction aid (4) according to claim 1, wherein both angle elements (14, 15) are configured equally and the support element (6) has two connecting sections (16).

10: A continuous track (1) for a machine, which has an upper side, which preferably has a profiling (2) with elevations, and with at least one traction aid (4), which is arranged on the upper side, preferably between two elevations of the profiling (2), wherein the traction aid (4) is formed according to claim 1.
